(19) United States
(12) Patent Application Publication
(10) Pub. No.: US 2005/0078592 A1
(43) Pub. Date: Apr. 14, 2005

(54) Optical information recording method, optical information recording apparatus, and optical information recording/reproducing apparatus

(75) Inventors: Hideyoshi Horimai, Yokohama (JP); Yoshio Oaki, Yokohama (JP)

Correspondence Address: KODA & ANDROLIA, 2029 CENTURY PARK EAST, SUITE 1430, LOS ANGELES, CA, 90067-3024, US

(73) Assignee: Optware Corporation

(21) Appl. No.: 10/840,840

(22) Filed: May 7, 2004

(30) Foreign Application Priority Data
May 13, 2003 (JP) 2003-171392
Apr. 19, 2004 (JP) 2004-122601

(51) Int. Cl. G11B 7/00

(52) U.S. Cl. 369/112.01; 369/118

(57) ABSTRACT

[OBJECT] An object is to provide an optical information recording method for recording information accurately on an information recording layer of a recording medium by utilizing interference between information light which carries information by spatial modulation and recording-specific reference light and an optical information recording/reproducing apparatus.
[MEANS TO SOLVE] Information light 1 which carries information by spatial modulation and recording-specific reference light 2 are interfered with each other in an information recording layer 4 of a recording medium, and diffusion of the recording-specific reference light 2 is controlled so as not to cause interference between each recording-specific reference light 2 in the information recording layer 4 when information is recorded through the interference pattern.

### FIELD OF THE INVENTION

The present invention relates to an optical information recording method for recording information on an information recording layer of a recording medium utilizing interference between information light to which information is added by performing spatial modulation and recording-specific reference light and to an optical information recording/reproducing apparatus.

### BACKGROUND ART

Conventionally, in holographic recording for recording information onto a recording medium using holography, in general, the interference pattern generated by overlapping the information light carrying image information and recording-specific reference light in the recording medium is written onto the recording medium. For reproducing the recorded information, reproduction-specific reference light is irradiated to the recording medium for diffracting the interference pattern so as to reproduce the image information.

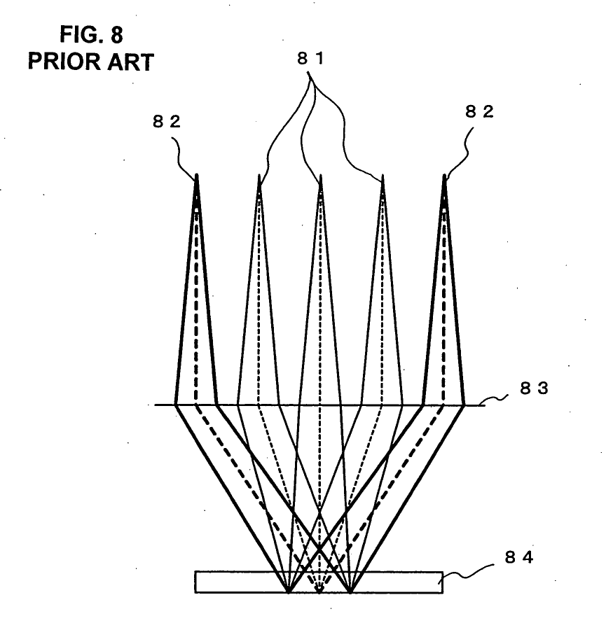

FIG. 8 is an illustration showing the concept of the relation between the information light and the recording-specific reference light in a conventional holographic recording. Information light 81 and recording-specific reference light 82 (shown by a thick line in FIG. 8) enter an objective lens 83 from the upper direction and irradiated onto a prescribed region in an information recording layer 84 of a recording medium. Thus, it is possible to three-dimensionally record the interference pattern, which is generated when the information light 81 and the recording-specific reference light 82 interfere with each other, in the information recording layer 84 as information. That is, it can be recorded not only in the plane direction but also in the thickness direction.

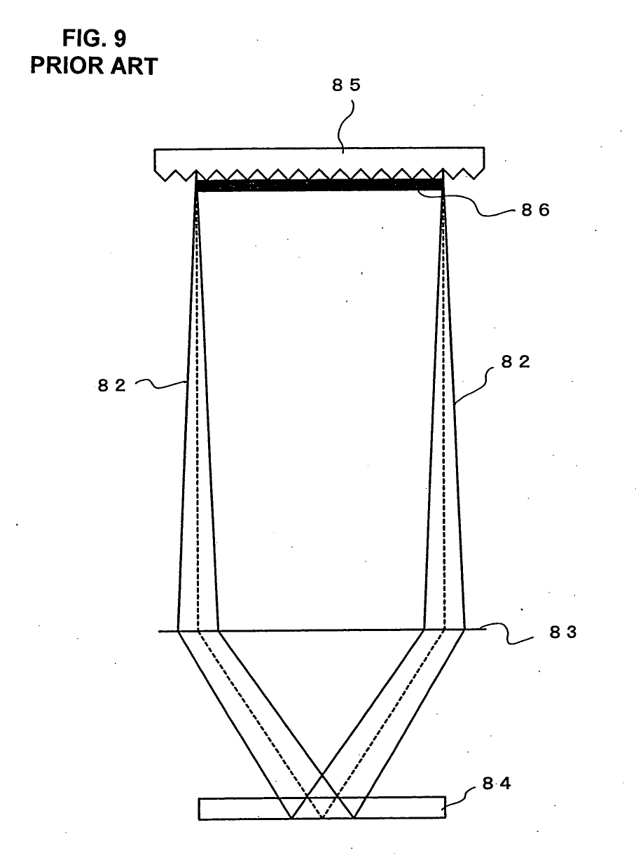

FIG. 9 is a schematic view showing a section regarding the cross-sectional shape taken out from a conventional recording-specific reference light generator for generating the recording-specific reference light 82. In the conventional recording-specific reference light generator for generating the recording-specific reference light 82, a shielding mask 86 is disposed to be in contact with a diffusion plate 85, which determines the cross-sectional shape of the recording-specific reference light.

[Patent Document 1] Japanese Unexamined Patent Publication No. 11-311938

### DISCLOSURE OF THE INVENTION

### PROBLEM THE INVENTION ATTEMPTS TO SOLVE

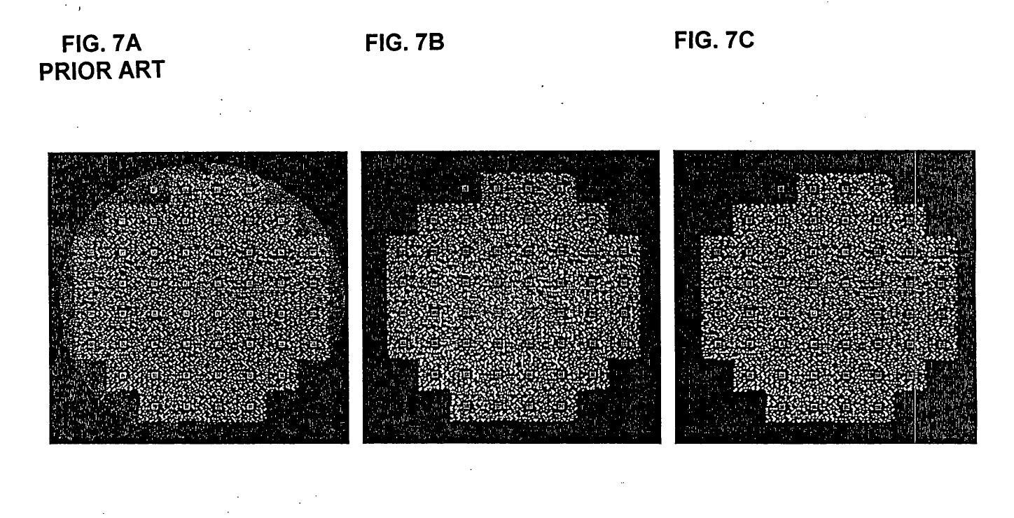

However, when information recorded through conventional holographic recording is reproduced, there are a number of noises being detected. FIG. 7A shows the case where the information recorded through the conventional holographic recording is reproduced. In FIG. 7A, each of the recorded information from bottom to top in order has a square in the same size, respectively, in four lines, six lines, eight lines, eight lines, eight lines, six lines, four lines with a small square in the center and the periphery being filled with dots except for the square on the upper-left. In FIG. 7A, a circular noise is also reproduced in addition to the recorded pattern.

The inventors of the present invention has found out that the noise is caused by the recording-specific reference light 82. Conventionally, the recording-specific reference light 82 is formed as light rays with a prescribed diffusion angle to be diffused light by the diffusion plate 85.

Therefore, as shown in FIG. 8 and FIG. 9, the recording-specific reference light 82 is diffused before reaching the objective lens 83 spreading out from the cross-sectional shape determined by the shielding mask 86.

As a result, the recording-specific reference light 82 enters the objective lens 83 by being diffused onto the section shielded by the shielding mask 86 so that the each recording-specific reference light 82 overlaps with each other in the information recording layer, thereby forming an interference pattern. The interference pattern caused by the overlap of each recording-specific reference light 82 becomes the noise of the information recorded in the recording medium, which hinders the accurate recording.

Further, in the case where a reflector layer is provided in the recording medium as in Japanese Unexamined Patent Publication No. 11-311938, the recording-specific reference light entering the recording medium, after passing through the information recording layer of the recording medium, is reflected by the reflector layer of the recording medium and passes the information recording layer once again. Each reflected light of the recording-specific reference light overlaps with each other in the information recording layer 84, thereby forming the interference pattern.

An object of the present invention is to provide an optical information recording method for accurately recording information on an information recording layer of a recording medium by utilizing interference between information light to which information is added by performing spatial modulation and recording-specific reference light and an optical information recording/reproducing apparatus.

### MEANS TO SOLVE THE PROBLEMS

In order to achieve the foregoing object, the optical information recording method of the present invention is an optical information recording method for recording information by an interference pattern which is generated by making information light to which information is added by performing spatial modulation and recording-specific reference light interfere with each other in an information recording layer, characterized in that diffusion of the recording-specific reference light is controlled so that there is no interference generated between each of the recording-specific reference light in the information recording layer.

Further, in the optical information recording method of the present invention, control of diffusion of the recording-specific reference light may be performed by shielding a part of the recording-specific reference light by a shielding means provided in a position being away by a prescribed distance from a diffusing means for diffusing the recording-specific reference light.

Furthermore, in the optical information recording method of the present invention, control of diffusion of the recording-specific reference light may be performed by shielding a part of the recording-specific reference light by a plurality of shielding means provided in positions distant from each other along an optical axis of the recording-specific reference light.

Moreover, in the optical information recording method of the present invention, control of diffusion of the recording-specific reference light may be performed by shielding a part of the recording-specific reference light in a prescribed distance by a shielding means provided along an optical axis of the recording-specific reference light.

Further, in the optical information recording method of the present invention, it is preferable that the recording-specific reference light be formed asymmetrically with respect to the optical axis.

Also, an optical information recording apparatus of the present invention has: a light source for emitting light ray flux; an information light generating means for generating information light carrying information by spatially modulating light ray flux emitted from the light source; a recording-specific reference light generating means for generating recording-specific reference light using the information light emitted from the light source; and a recording optical system for irradiating the information light and the recording-specific reference light onto an information recording layer so that information is recorded in the information recording layer by an interference pattern generated by interference between the information light and the recording-specific reference light, characterized in that the recording-specific reference light generating means comprises a diffusing means for diffusing the recording-specific reference light and a shielding means provided being away by a prescribed distance from the diffusing means along an optical axis of the recording-specific reference light.

Also, another optical information recording apparatus of the present invention has: a light source for emitting light ray flux; an information light generating means for generating information light carrying information by spatially modulating light ray flux emitted from the light source; a recording-specific reference light generating means for generating recoding reference light using the information light emitted from the light source; and a recording optical system for irradiating the information light and the recording-specific reference light onto an information recording layer so that information is recorded in the information recording layer by an interference pattern generated by interference between the information light and the recording-specific reference light, characterized in that the recording-specific reference light generating means comprises a plurality of shielding means for shielding a part of the recording-specific reference light, which are provided away from each other along an optical axis of the recording-specific reference light.

Also, still another optical information recording apparatus of the present invention has: a light source for emitting light ray flux; an information light generating means for generating information light carrying information by spatially modulating light ray flux emitted from the light source; a recording-specific reference light generating means for generating recoding reference light using the information light emitted from the light source; and a recording optical system for irradiating the information light and the recording-specific reference light onto an information recording layer so that information is recorded in the information recording layer by an interference pattern generated by interference between the information light and the recording-specific reference light, characterized in that the recording-specific reference light generating means comprises a shielding means for shielding a part of the recording-specific reference light in a prescribed distance along an optical axis of the recording-specific reference light.

Further, in the optical information recording apparatus of the present invention, it is preferable that the shielding means be in a shape in which convex portions are protruded radially from a circular shape. Especially, it is preferable that the convex portions be provided asymmetrically with respect to the optical axis.

Further, in the optical information recording apparatus of the present invention, it is preferable that the shielding means be disposed in a position to be alternately used with a means for spatially modulating light ray flux emitted from a light source in the information light generating means.

Also, an optical information recording/reproducing apparatus of the present invention comprises: in addition to the above-described optical information recording apparatus, a reproduction-specific reference light generating means for generating reproduction-specific reference light using light ray flux emitted from the light source; a recording/reproducing optical system for converging reproduction light generated from the information recording layer when the reproduction-specific reference light is irradiated thereto; and a detecting means for detecting the reproduction light converged by the recording/reproducing optical system.

Further, in the optical information recording/reproducing apparatus of the present invention, it is preferable that the recording/reproducing optical system comprise a mask for shielding reflected light of the reproduction-specific reference light and the mask is disposed on an image surface in the recording/reproducing optical system.

### EFFECT OF THE INVENTION

In the present invention, diffusion of the recording-specific reference light is controlled so that there is no interference between each recording-specific reference light generated in the information recording layer. Since there is no interference between the each recording-specific reference light generated in the information recording layer, accurate information recording can be achieved.

Further, by shielding a part of the recording-specific reference light using a shielding means provided being away by a specific distance from diffusing means for diffusing the recording-specific reference light, diffusion of the recording-specific reference light onto the shielded section becomes less since the distance between with the diffusing means is long. Thus, by a simple method which is to change the position of the shielding means, interference between each recording-specific reference light in the information recording layer can be decreased.

Further, by shielding a part of the recording-specific reference light using a plurality of shielding means provided in positions distant from each other along an optical axis of the recording-specific reference light, the cross-sectional shape of the recording-specific reference light which is formed by being shielded in a part by a first shielding means can be prevented from being spread again afterwards to the shielded section by diffusion or diffraction of the recording-specific reference light by a next shielding means. Thereby, the recording-specific reference light with a desired cross-sectional shape can be supplied and the interference between each recording-specific reference light in the information recording layer can be decreased.

Further, by shielding a part of the recording-specific reference light in a prescribed distance by a shielding means provided in a position along an optical axis of the recording-specific reference light, a part of the recording-specific reference light is shielded in a prescribed distance by a shielding means. Thus, the recording-specific reference light to be diffused onto the shielding means side can be removed, the recording-specific reference light with a desired cross-sectional shape can be supplied, and the interference between each recording-specific reference light in the information recording layer can be decreased.

In addition, when the recording-specific reference light is formed to be asymmetrical with respect to the optical axis, the recording-specific reference light symmetrical to the recording-specific reference light entering the recording medium is shielded by the convex portion. Thus, it is possible to decrease the interference between the reflected light of each recording-specific reference light reflected by the reflector layer of the recording medium.

Further, since one of the shielding means is in a circular shape with the optical axis of the recording-specific reference light being the center and the other is in a shape in which the convex portion is protruded radially from the circular shape, it is possible to decrease the interference between each recording-specific reference light in the information recording layer due to the shape shielded by the circular shielding means and, further, due to the shape shielded by the radial convex portion, it is possible to decrease the interference between each reflected light of the recording-specific reference light reflected in the recording medium. Therefore, more accurate information recording can be achieved.

Also, in the optical information recording apparatus or the optical information recording/reproducing apparatus of the present invention, when the shielding means is disposed in a position to be alternately used as a means for spatially modulating light ray flux emitted from a light source in the information light generating means, the recording-specific reference light formed by the shielding means is focused onto the image surface of the optical system as in the same manner as that of the information light and irradiated onto the recording medium by the objective lens. Thereby, information can be accurately recorded.

Also, in the optical information recording/reproducing apparatus of the present invention, when the recording/reproducing optical system comprises a mask for shielding the reflected light of the reproduction-specific reference light and the mask is disposed in the image surface of the recording/reproducing optical system, the reflected light of the reproduction-specific reference light reflected by the reflector layer of the recording medium focuses onto the position of the mask. Therefore, by the mask, a larger amount of the reflected light of the reproduction-specific reference light can be removed and the noise can be removed.

### BEST MODE FOR CARRYING OUT THE INVENTION

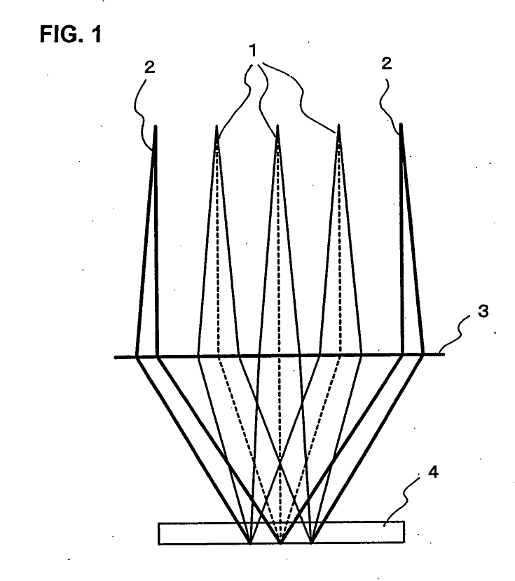

In the followings, embodiments of the present invention will be described by referring to the accompanying drawings. FIG. 1 is an illustration showing the concept of the relation between the information light and the recording-specific reference light according to the present invention. In the present invention, information light 1 has the same configuration as that of the conventional case and information to be recorded is added thereto by performing spatial modulation. Recording-specific reference light 2 is for forming holography by being interfered with the information light.

In FIG. 1, the outer side of the recording-specific reference light 2 being diffused to be spread out enters an objective lens 3. However, the inner side (on the information light 1 side) is the light ray parallel to the optical axis having the shape which is shielded by a shield for controlling the diffusion of the recording-specific reference light. Therefore, when being irradiated to a prescribed region in an information recording layer 4 of a recording medium by the objective lens 3, the interference between each recording-specific reference light 2 can be decreased. Also, one of the recording-specific reference light 2 is irradiated onto the prescribed region of the information recording layer 4 so that interference is caused between the information light 1 and the recording-specific reference light 2. Thereby, accurate information can be recorded in the information recording layer 4.

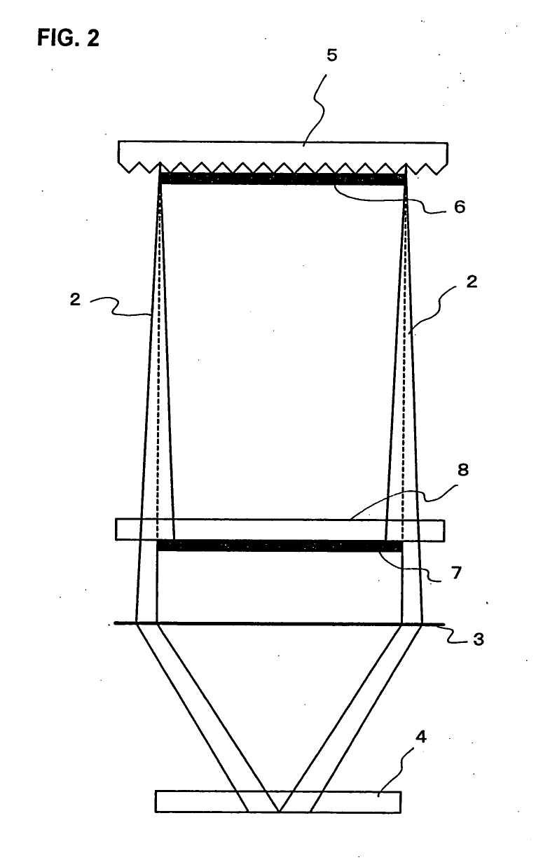

Next, FIG. 2 to FIG. 4 are schematic views showing the section relating to the cross-sectional shape taken out from the recording-specific reference light generator for generating the recording-specific reference light 2.

In FIG. 2, the recording-specific reference light generator for generating the recording-specific reference light 2 comprises a plurality of shields 6, 7 provided being away from each other along the optical axis of the recording-specific reference light. The recording-specific reference light 2 is formed in a desired cross-sectional shape since a part of which is shielded by a first shield 6. However, it spreads our again by diffusion, diffraction and the like. This is the same as that of the conventional case and the recording-specific reference light 2 diffuses into the inner side shielded by the shielding mask 6. However, by forming it into the desired cross-sectional shape once again through a second shield 7 provided in a distant position, most of the light rays towards the inner side can be removed and the diffusion of the recording-specific reference light 2 can be controlled.

In FIG. 2, the shield 6 is disposed to be in contact with the diffusion plate 5, however, it is not necessarily limited to this position. Further, the shield 7 disposed on the midway position of the optical path may be supported by a supporting member such as a transparent glass substrate 8 or the like. As the shield, a mask made of a material which has a shielding characteristic against the wavelength of the light source may be used.

Although there are two shields in shown FIG. 2, three or more shields may be used. Further, preferable space in between the shields is some ten mm or more since the control of the diffusion becomes insufficient when the distance there between is too short. It is sufficient to provide the space of 50 mm or more. Meanwhile, when the shields are disposed being away from each other, the apparatus becomes large-scaled. Thus, an appropriate distance is to be selected in consideration over both points of view. As will be described later, the second shield 7 (the last shield when three or more shields are used) is preferable to be disposed in a position in the optical system of the information recording apparatus which can be alternately used as information expressing device for generating the information light.

In addition, when there is a limit in the spread of the recording-specific reference light diffused by the diffusion plate 5, it is possible to remove the light rays towards the inner side by one shield through providing the shield in a position sufficiently distant from the diffusion plate 5. Thereby, diffusion of the recording-specific reference light 2 can be controlled.

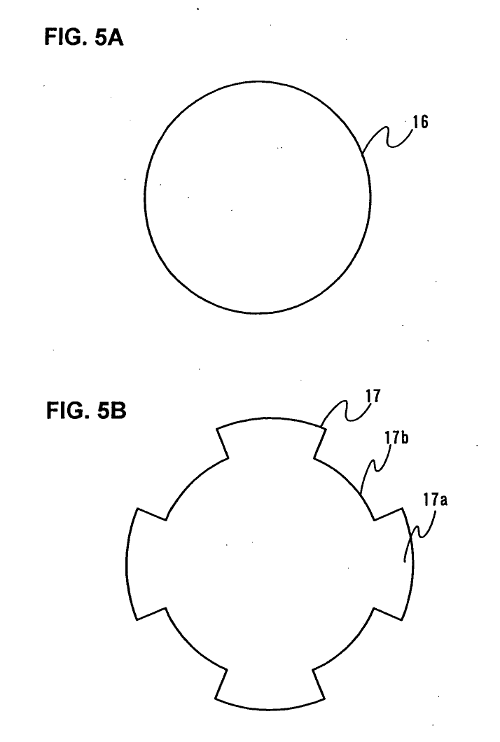

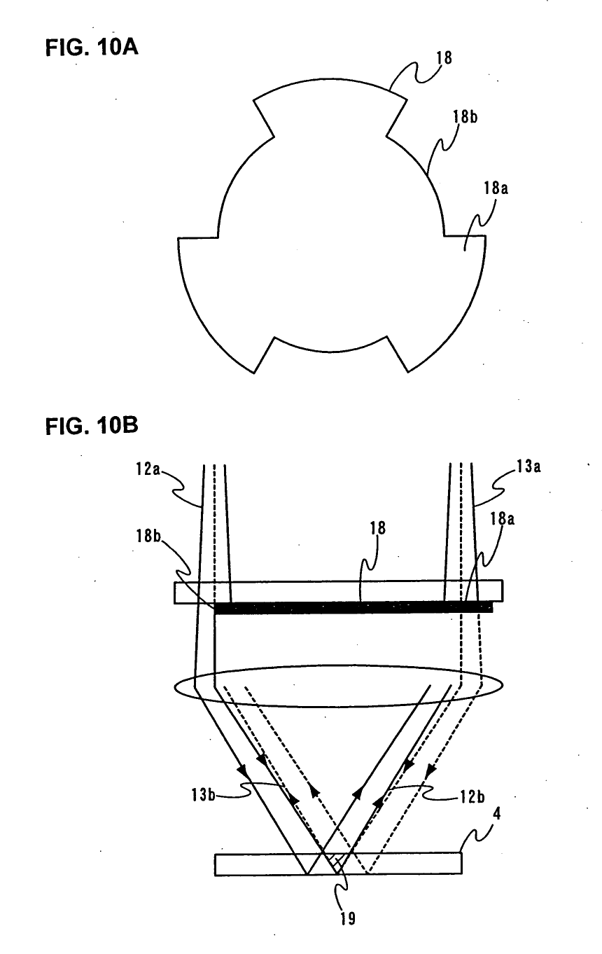

In general, a circular shield is used in many cases. However, it is not limited to this shape. As will be described later, it may be in the shapes shown in FIG. 5B and FIG. 10A. A plurality of the shields may not be in the same shape, however, it is preferable that the shield in the rear row (numeral 7 in FIG. 2) overlap with the section shielded by the shield in the front row (numeral 6 in FIG. 2).

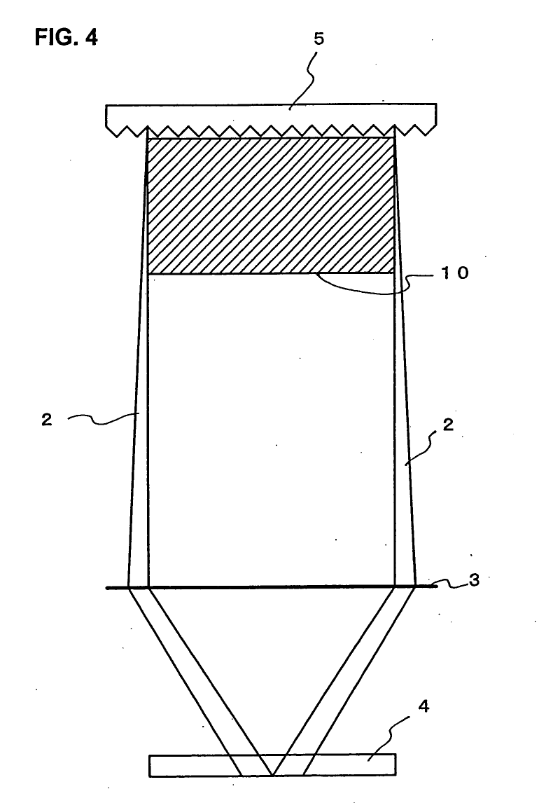

In the configuration show in FIG. 2, by reproducing the recorded information through the optical system in which circular masks as the first and second shields 6, 7 are disposed with 50 mm space therebetween, it is possible to obtain the same result (FIG. 7C) as that of the case where a shield 10 with 50 mm length as shown in FIG. 4 to be described later.

As a modification example in which shields in different shapes are used, as shown in FIG. 5A and FIG. 5B, it is possible to use a circular mask as a first shield 16 and a mask in which convex portions 17a are radially protruded from the circular shape with the same diameter as that of the shield 16. By employing the configuration as shown in FIG. 5, the recording-specific reference light becomes a ring shape since the circular-shape portion common to the first and second shields 16, 17 is shielded. Further, the section corresponding to the convex portion 17a of the second shield 17 is also shielded so that only a concave portion 17b which is disrupted in the circumferential direction of the ring shape is irradiated onto the recording medium.

Thus, by the circular-shape portion common to the first and second shields 16, 17, diffusion in a ring shape towards the inner side can be controlled so as to decrease the interference between each recording-specific reference light in the information recording layer.

Further, as for the recording-specific reference light irradiated onto the recording medium after passing through the concave portion 17b of the second shield 17, most of the light rays from the concave portion 17b towards the convex portion 17a can be removed by the convex portion 17a. Thereby, diffusion of the recording-specific reference light in the circumferential direction can be controlled and the interference in the circumferential direction between each of the recording-specific reference light and between each of the reflected light of the recording-specific reference light can be decreased. The recording-specific reference light is diffused by the diffusion plate in all directions so that it is diffused not only in the inner side of the ring shape but also in the circumferential direction of the ring shape.

Further, as shown in FIG. 10A and FIG. 10B, when convex portions 18a of the second shield 18 is formed to be asymmetrical with respect to the optical axis, a recording-specific reference light 13a symmetrically with respect to a recording-specific reference light 12a which has entered the recording medium after passing through a concave portion 18b is shielded by the convex portion 18a. In FIG. 10B, shown by a dotted line is virtual light rays when the recording-specific reference light 13a shielded by the convex portion 18a enters the recording medium 4. It is therefore possible to decrease the interference between reflected light 12b, 13b of the recording-specific reference light reflected by the reflector layer of the recording medium, which is generated otherwise in the conventional case in a region 19 as shown in FIG. 10B.

In order to completely prevent the interference between each reflected light of the recording-specific reference light, it is necessary that the convex portion 18a of the second shield 18 is larger than the concave portion 18b provided in the symmetrical position with respect to the optical axis. Meanwhile, shielded by the convex portion 18a, the amount of the recording-specific reference light irradiated to the recording medium decreases. Thus, the amount of irradiation onto the recording medium can be increased with less convex portion 18a. Accordingly, it is preferable that the second shield is so formed that the convex portion 18a and the concave portion 18b are provided symmetrically with respect to the optical axis. The number of the convex portion 18a is not limited to three as shown in FIG. 10.

In FIG. 5 and FIG. 10, when there is a limit in the spread of the recording-specific reference light diffused by the diffusion plate, it is possible to remove the light rays towards the inner side and the circumferential direction through providing the second shields 17, 18 in the positions sufficiently distant from the diffusion plate. Thereby, diffusion of the recording-specific reference light 2 can be controlled without providing the first shield 16.

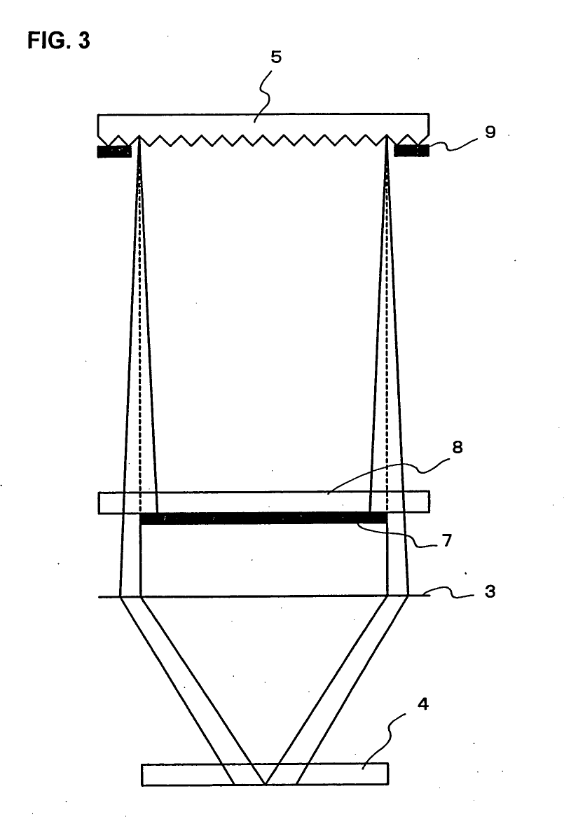

FIG. 3 is a modification example in which a plurality of shields do not overlap with each other. In FIG. 3, a ring shape mask complementary to the second circular shield 7 is used as a first shield 9, and the light entering the objective lens 3 as the recording-specific reference light 2 is the light being diffused towards the outer side by the diffusion plate 5. When the distance between the shield 9 and the shield 7 is sufficiently distant, the diameter of the ring of the shield 9 may be larger than that of the shield 7. Further, when there is a limit in the beam diameter, the shield 9 is unnecessary.

In FIG. 4, the recording-specific reference light generator for generating the recording-specific reference light 2 comprises a shield 10 provided over a specific distance along the optical axis of the recording-specific reference light. A part of the recording-specific reference light 2 is shielded by the shield 10 in a specific distance so that the recording-specific reference light diffusing onto the shield 10 side can be removed. Thereby, the recording-specific reference light with a desired cross-sectional shape can be obtained.

The length of the shield 10 is preferable to be some ten mm or more since the control of the diffusion becomes insufficient when it is too short, and it is sufficient when the length is 50 mm or more. Meanwhile, the apparatus becomes large-scaled when the shield is long and the varsity of the possible design of the optical system is limited. Thus, an appropriate distance is to be selected in consideration over both points of view.

In FIG. 4, the shield 10 is disposed to be in contact with the diffusion plate 5. However, it is not necessarily limited in this position and may be disposed in the midway of the optical path. Further, it is preferable that the shield 10 be disposed in such a manner that the end position of the shield 10, in the optical system of the information recording apparatus, is disposed in the position which can be alternately used as the information expressing device for generating the information light.

Also, by providing the sidewalls of the shield 10 in cornice form, reflection of the recording-specific reference light 2 by the sidewalls of the shield 10 can be decreased and diffusion of the recording-specific reference light can be further controlled. In general, the shield 10 in circular shape is used in many cases, however, it is not limited to this shape. For example, the cross section may be in the shapes as shown in FIG. 5B and FIG. 10A.

FIG. 7B shows the case where, with the configuration shown in FIG. 4, the recorded information is reproduced by the optical system in which the shield 10 of 6 mm or more in length along the optical axis is employed. As shown in FIG. 7B, with the configuration as shown in FIG. 4, the circular noise can be decreased compared to the conventional case, however, it can be seen that there is still a little circular noise remained.

FIG. 7C shows the case where, with the configuration shown in FIG. 4, the recorded information is reproduced by the optical system in which the shield 10 of 50 mm or more in length along the optical axis is employed. In FIG. 7C, there is no circular noise displayed conventionally and the recorded information is clearly reproduced.

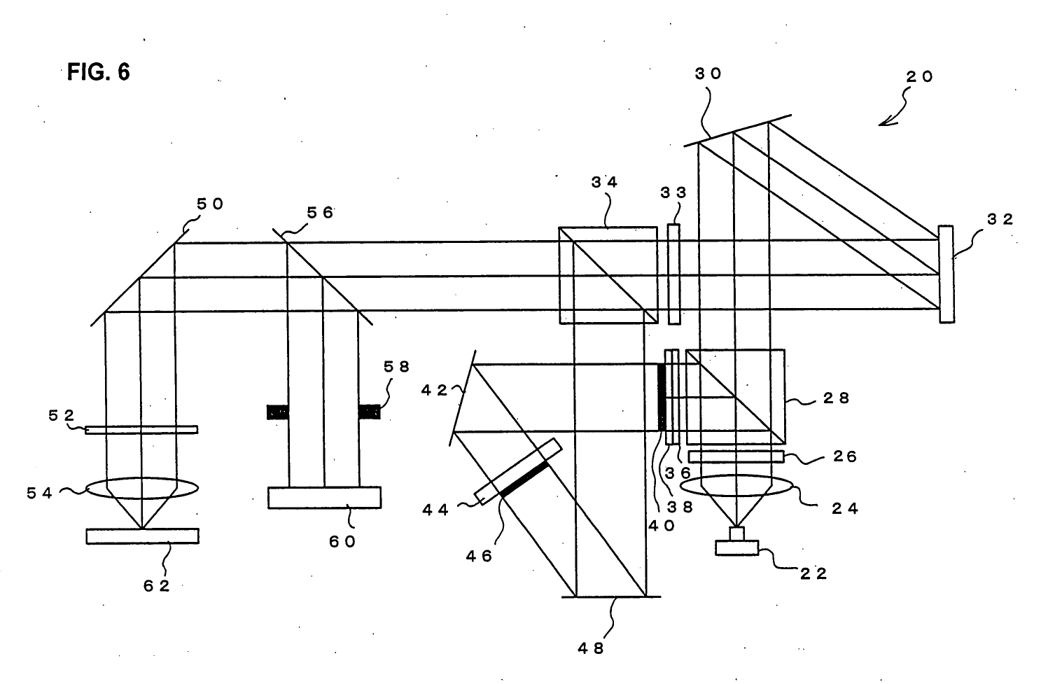

FIG. 6 is a schematic cross section showing an embodiment of the optical information recording/reproducing apparatus 20 of the present invention. The optical information recording/reproducing apparatus 20 comprises a light source 22, a collimator lens 24, a half-wave plate 26, a beam splitter 28, a mirror 30, a spatial light modulator (information expressing device) 32, a shutter 33, a half mirror 34, a half-wave plate 36, a diffusion plate 38, a first shielding mask 40, a mirror 42, a glass substrate 44, a second shielding mask 46, mirrors 48, 50, a quarter-wave plate 52, an objective lens 54, a half mirror 56, a ring mask 58, and an optical detector 60.

As the light source 22, for example, a semiconductor laser which emits light ray flux of coherent linear polarized light can be used. The light ray flux emitted from the light source 22 becomes substantially parallel light rays by the collimator lens and converted into P-polarization and S-polarization by the half-wave plate 26. Then, one of the P-polarization or the S-polarization becomes the base for information light after passing through the beam splitter having a half reflecting surface which is tilted by 45° with respect to the optical axis direction of the collimator lens 24 and the other becomes the reference light for recording and reproduction by being reflected by the beam splitter 28.

The light to be the base for the information light is reflected by the mirror 30 towards the spatial light modulator (information expressing device) 32. As the spatial light modulator (information expressing device) 32, for example, a DMD (digital micro mirror device) can be used and it spatially modulates the light to be the base for the information light for adding the information to generate the information light. The information light is guided to enter the half mirror 34. Japanese Patent Application No. 2003-29968 by the applicant of the present invention discloses the use of the DMD as the spatial light modulator (information expressing device).

The reference light for recording and reproduction is changed into a half wavelength by the half-wave plate 36 and diffused by the diffusion plate 38, and a part of which is shielded by the first shielding mask 40 and reflected by the mirrors 42, 48 towards the half mirror 34. In the embodiment, the glass substrate 44 and the second shielding mask 46 are disposed between the mirror 42 and the mirror 48 so as to shield a part of the reference light for recording and reproduction once again.

The reference light for recording and reproduction generated as described is reflected by the half mirror 34. In the case of the recording-specific reference light, it is synthesized with the information light by the half mirror 34 and reflected by the mirror 50 towards the recording medium 62. The information light and the recording-specific reference light overlaps with each other in the information recording layer of the recording medium 62 and the interference pattern is recorded as information.

In the case of the reproduction-specific reference light, the information light is shielded by the shutter 33 so that only the reproduction-specific reference light reflected by the half mirror 34 is reflected by the mirror 50 towards the recording medium 62. It is then irradiated onto the recording medium 62 by the objective lens 54 through the quarter-wave plate 52. Then, the reproduction light which is generated when the reproduction-specific reference light is diffracted by the interference pattern recorded in the information recording layer of the recording medium and then reflected by the reflector layer of the recording medium 62 transmits through the objective lens 54, is reflected by the mirror 50, and is reflected by the half mirror 56 towards the optical detector 60. By providing the ring mask 58 between the half mirror 56 and the optical detector 60, excessive light rays such as the reflected light of the reproduction-specific reference light can be removed so that the noise can be decreased. As the optical detector 60 as a detection device, a CMOS sensor, a CCD array sensor or the like can be used for reproducing information by detecting the reproduction light.

In the embodiment, the optical system from the collimator lens 24 to the spatial light modulator (information expressing device) 32 is the information light generator, the optical system from the collimator lens 24 to the mirror 48 is the recording-specific reference light generator and the reproduction-specific reference light generator, from the half mirror 34 to the objective lens 54 is the recording optical system, and from the objective lens 54 to the ring mask 58 is the recording/reproducing optical system.

In the embodiment, the optical information recording/reproducing apparatus comprising the recording/reproducing optical system and the detection device is described. However, the recording/reproducing optical system and the detection device can be omitted to be used as the optical information recording apparatus.

Also, the first and second shielding masks 40 and 46 are employed as the shield. However, other shield described above as shown in FIG. 3 to FIG. 5 may also be employed.

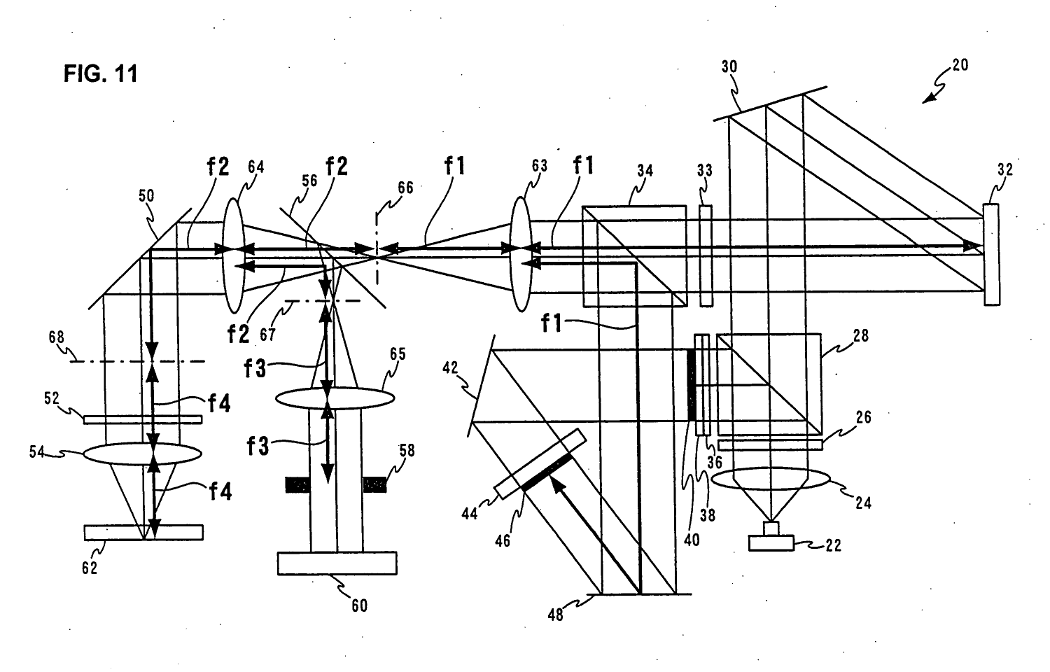

FIG. 11 shows the case where a group of lenses 63 to 65, which build an image displayed in the spatial light modulator 32 again as a real image, are inserted in the information recording/reproducing apparatus shown in FIG. 6. It is preferable to decrease the noise in the information to be recorded and reproduced by utilizing the group of lenses as the spatial frequency filter. In FIG. 11, the first to third lens 63 and lens 64 has a first to third focal distance f to f3, respectively, and the objective lens 54 has a focal distance f4. FIG. 11 is an illustration showing the positioning of the structural members and not intended to show the actual dimensions.

The first lens 63 is disposed in the position distant for the length of the first focal distance f1 from the spatial light modulator 32 for generating the information light. The second lens 64 is disposed in the position distant for the length of the second focal distance f2 from a focal point 66 of the first lens 63. The third lens 65 is disposed in the position distant for the length of the third focal distance f3 from a focal point 67 of the second lens 64. The objective lens 54 is disposed in the position distant for the length of the focal distance f4 from an image surface of the second lens 64.

By disposing the group of lenses 54, 63 to 65 as described above, the spatially modulated information light is focused onto the image surface 68 of the second lens by the first and the second lenses 63, 64, and the built image can be irradiated onto the recording medium 62 by the objective lens 54. Further, for reproduction, the reproduction light reproduced from the recording medium 62 is focused onto the image surface of the objective lens 54 by the objective lens 54 and then focused onto the image surface of the third lens 65 by the second and third lenses 64, 65.

Further, it is preferable to dispose the second shielding mask 46 in such a manner that the distance between with the first lens 63 becomes the first focal distance f1. Thereby, the spatial light modulator 32 and the shielding mask 46 are to have an optical relation which can be alternately used. Therefore, the reference light for recording- and reproduction-specific reference light formed by the second shielding mask 46 is focused on to the image surface 68 of the second lens by the first and second lenses 63, 64 as in the same manner as that of the information light. Thus, the real images of the recording- and reproduction-specific reference light are irradiated onto the recording medium 62 of the objective lens 54 so that the information can be accurately recorded.

Further, the ring mask 58 is preferable to be disposed in the position distant for the length of the third focal distance f3 from the third lens 65. Thereby, the reflected light of the reproduction-specific reference light reflected by the reflector layer of the recording medium 62 is focused onto the position of the ring mask 58. Thus, a larger amount of the reflected light of the reproduction-specific reference light can be removed by the ring mask 58 and the noise can be removed.

In FIG. 11, the first lens 63 is disposed between the half mirror 34 and the half mirror 56, the second lens 64 is disposed between the half mirror 56 and the mirror 50, and the third lens 65 is disposed between the half mirror 56 and the ring mask 58. However, the positioning is not limited to this. For example, if both of the first and second lenses 63, 64 can be disposed in the position closer to the recording medium 62 side than the half mirror 56, the third lens 65 can be omitted.

The present invention is not limited to the above-described embodiments but various modifications are possible as necessary.

### BRIEF DESCRIPTION OF THE DRAWINGS

[FIG. 1] An illustration showing the concept of the relation between information light and recording-specific reference light of the present invention;

[FIG. 2] A schematic view showing a part of a recording-specific reference light generator of the present invention;

[FIG. 3] A schematic view showing a part of a recording-specific reference light generator of the present invention;

[FIG. 4] A schematic view showing a part of a recording-specific reference light generator of the present invention;

[FIG. 5] A plan view showing an embodiment of the shape of a shield;

[FIG. 6] A schematic cross section showing an embodiment of an optical recording/reproducing apparatus of the present invention;

[FIG. 7] An illustration showing the case where information recorded by using holographic recording is reproduced;

[FIG. 8] An illustration showing the concept of the relation between information light and recording-specific reference light of the related art;

[FIG. 9] A schematic view showing a part of recording-specific reference light generator of the related art;

[FIG. 10] A plan view showing an embodiment of the shape of a shield; and

[FIG. 11] A schematic cross section showing an embodiment of an optical information recording/reproducing apparatus of the present invention.

1. An optical information recording method for recording information by an interference pattern which is generated by making information light to which information is added by performing spatial modulation and recording-specific reference light interfere with each other in an information recording layer, characterized in that
diffusion of said recording-specific reference light is controlled so that there is no interference generated between each of said recording-specific reference light in said information recording layer.

2. The optical information recording method according to claim 1, characterized in that control of the diffusion of said recording-specific reference light is performed by shielding a part of said recording-specific reference light by a shielding means provided in a position being away by a prescribed distance from a diffusing means for diffusing said recording-specific reference light.

3. The optical information recording method according to claim 1, characterized in that control of the diffusion of said recording-specific reference light is performed by shielding a part of said recording-specific reference light by a plurality of shielding means provided in positions distant from each other along an optical axis of said recording-specific reference light.

4. The optical information recording method according to claim 1, characterized in that control of the diffusion of said recording-specific reference light is performed by shielding a part of said recording-specific reference light in a prescribed distance by a shielding means provided along an optical axis of said recording-specific reference light.

5. The optical information recording method according to any one of claims 1 to 4, characterized in that said recording-specific reference light is formed asymmetrically with respect to the optical axis.

6. An optical information recording apparatus, comprising: a light source for emitting light ray flux; an information light generating means for generating information light carrying information by spatially modulating light ray flux emitted from said light source; a recording-specific reference light generating means for generating recording-specific reference light using said information light emitted from said light source; and a recording optical system for irradiating said information light and said recording-specific reference light onto an information recording layer so that information is recorded in said information recording layer by an interference pattern generated by interference between said information light and said recording-specific reference light, characterized in that
said recording-specific reference light generating means comprises a diffusing means for diffusing said recording-specific reference light and a shielding means provided being away by a prescribed distance from said diffusing means along an optical axis of said recording-specific reference light.

7. An optical information recording apparatus, comprising: a light source for emitting light ray flux; an information light generating means for generating light information carrying information by spatially modulating light ray flux emitted from said light source; a recording-specific reference light generating means for generating recording reference light using said information light emitted from said light source; and a recording optical system for irradiating said information light and said recording-specific reference light onto an information recording layer so that information is recorded in said information recording layer by an interference pattern generated by interference between said information light and said recording-specific reference light, characterized in that
said recording-specific reference light generating means comprises a plurality of shielding means for shielding a part of said recording-specific reference light, which are provided away from each other along an optical axis of said recording-specific reference light.

8. An optical information recording apparatus, comprising: a light source for emitting light ray flux; an information light generating means for generating information light carrying information by spatially modulating light ray flux emitted from said light source; a recording-specific reference light generating means for generating recording reference light using said information light emitted from said light source; and a recording optical system for irradiating said information light and said recording-specific reference light onto an information recording layer so that information is recorded in said information recording layer by an interference pattern generated by interference between said information light and said recording-specific reference light, characterized in that
said recording-specific reference light generating means comprises a shielding means for shielding a part of said recording-specific reference light in a prescribed distance along an optical axis of said recording-specific reference light.

9. The optical information recording apparatus according to any one of claims 6 to 8, characterized in that said shielding means is in a shape in which convex portions are protruded radially from a circular shape.

10. The optical information recording apparatus according to claim 9, characterized in that said convex portions are provided asymmetrically with respect to an optical axis.

11. The optical information recording apparatus according to any one of claims 6 to 10, characterized in that said shielding means is disposed in a position to be alternately used with a means for spatially modulating light ray flux emitted from a light source in said information light generating means.

12. An optical information recording/reproducing apparatus, further comprising, in addition to the optical information recording apparatus according to any one of claims 6 to 11, a reproduction-specific reference light generating means for generating reproduction-specific reference light using light ray flux emitted from said light source; a recording/reproducing optical system for converging reproduction light generated from said information recording layer when said reproduction-specific reference light is irradiated thereto; and a detecting means for detecting said reproduction light converged by said recording/reproducing optical system.

13. The optical information recording/reproducing apparatus according to claim 12, characterized in that said recording/reproducing optical system comprises a mask for shielding reflected light of said reproduction-specific reference light and said mask is disposed on an image surface in said recording/reproducing optical system.
